(19) United States
(12) Patent Application Publication
(10) Pub. No.: US 2023/0105712 A1
(43) Pub. Date: Apr. 6, 2023

(54) ATHERMALIZED LENS DESIGN

(71) Applicant: VEONEER US, INC., SOUTHFIELD, MI (US)

(72) Inventors: ILYA FEDAROVICH, SOUTHFIELD, MI (US); PAUL LEONELLI, SOUTHFIELD, MI (US); SAMANTHA CHALUT, SOUTHFIELD, MI (US); NOAH JANKE, SOUTHFIELD, MI (US)

(73) Assignee: VEONEER US, INC., SOUTHFIELD, MI (US)

(21) Appl. No.: 17/494,957

(22) Filed: Oct. 6, 2021

(51) Int. Cl. G02B 7/02

(52) U.S. Cl. CPC G02B 7/028

(57) ABSTRACT

An optical sensor assembly is provided. The optical sensor includes a sensor and a lens assembly. The sensor may be configured to sense a light signal. The lens assembly may be configured to direct the light signal onto the sensor. The lens assembly may include a lens formed of a plastic material such that a thermal variation is introduced into a focal length of the lens based on temperature. The lens includes a thermal compensation spacer configured to induce a thermal correction in an opposite direction of the thermal variation to correct the focal length of the lens.

### BACKGROUND

The present disclosure is related an athermalized lens design.

Typically, optical glass may be used for lens design to minimize thermal expansion as optical glass has a low coefficient of thermal expansion and provides good optical quality. Optical glass has a high cost relative to other materials. Accordingly, an improved lens design is desirable.

### BRIEF SUMMARY

An optical sensor assembly is provided. The optical sensor may include a sensor and a lens assembly. The sensor may be configured to sense a light signal. The lens assembly may be configured to direct the light signal onto the sensor. The lens assembly may include a lens formed of a plastic material such that a thermal variation is introduced into a focal length of the lens based on temperature. The lens includes a thermal compensation spacer configured to induce a thermal correction in an opposite direction of the thermal variation to correct the focal length of the lens.

### BRIEF DESCRIPTION OF THE DRAWINGS

FIG. 1 is a schematic illustrating thermal variation in a lens assembly.

FIG. 2 is a sectional view of an optical sensor assembly.

FIG. 3 is a schematic diagram for a monitoring system.

FIG. 4 is a schematic diagram of a vehicle with sensors for monitoring the driver and outside environmental attributes.

### DETAILED DESCRIPTION

An athermalized lens design is described herein which compensates for thermal expansion through the inclusion of a thermal compensation material. This design may be implemented at a much lower cost than other designs. Thermal expansion is the tendency of matter to change its shape, area, and volume in response to a change in temperature. In the lens design, a thermal compensation material may be integrated into the lens housing so that the lens elements shift with the thermal expansion of the assembly maintaining the correct focal length. Due to the inclusion of the thermal compensation material, the lens elements can be designed with lower cost materials, such as optical plastic elements. Typically, optical glass may be used for lens design to minimize thermal expansion as optical glass has lower thermal expansion than optical plastics. In this case, with the integration of the thermal compensation material in the lens housing the higher thermal expansion of optical plastic can be compensated. Therefore, the lower cost plastic element can be used in the design.

Intrinsic athermalization is one technique that may be used to address temperature changes in lenses. This can include the selection of materials which are inherently insensitive to temperature change. In such an implmentation, automotive camera systems would rely upon intrinsic athermalization where optical component materials are selected for their lack of sensitivity to temperature. Because of this feature, components insensitive to temperature change are inherently more expensive.

Passive mechanical athermalization is another technique that may be used to address temperature changes in lens assemblies. Passive mechanical athermalization involves moving of optical elements by an amount that compensates for thermal defocus. The system described may applying passive mechanical athermalization. Other forms of passive mechanical athermalization may include: a series of linked rods with alternatively high and low expansion coefficients or a hydraulic method where fluid contained in the optical assembly acts as the athermalization material.

Athermalization through moving optics or mechanical refocus by piezo motors and actuators is yet another technique that can be used to address temperature changes in lens assemblies. Athermalization can be achieved through mechanically moving optics in conjunction with manual refocus or automatic focusing. This method often does not apply to automotive camera systems which often use fixed focus lens designs.

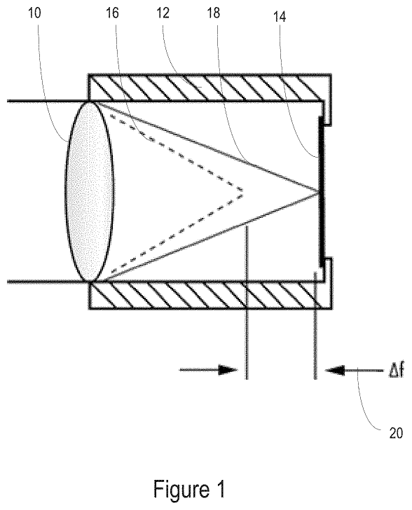

For an imaging lens assembly, it can be important to understand the thermal expansion properties of the materials which construct the assembly. As temperature can affect the lens materials, the focus, image scale, and refractive index of the lens components can change with a change in temperature. This means the optical quality of the lens can be significantly impacted by temperature. The change in a lens's refractive index with temperature (described by dn/dT) as well as mechanical element alignment can lead to a shift in the lens's focal length (Δf)—changing the focus position as shown in FIG. 1.

In the case of automotive advanced driver assistance systems (ADAS) that rely on camera imaging, the functionality of the algorithm depends on the quality of the optics. For this reason, it can be important that the lens assembly is designed to be athermalized where the back focal length shift over temperature of the lens shall be minimized or zero. In an automotive environment, the temperature may range for −40 degrees C. to 85 degrees C. This variation could see a back focal length change of +/−80 μm.

As described in more detail below, a thermal compensation material can be integrated into the lens housing so that the lens elements shift with the thermal expansion of the assembly maintaining the correct focal length. The thermal compensation material (e.g. a thermal compensation spacer) may include a material that has a known coefficient of thermal expansion (CTE) and other properties listed below (per selection criteria) and a matched length that equals to effective focal length (EFL) shift of the lens barrel assembly. The thermal compensation spacer may be added to the assembly so that MTF change due to EFL shift across negative and positive temperatures is less than 1%. Further, the thermal compensation material may have a Tensile Modulus (E)>1500 MPa. Soft materials are more prone to creep. When stressed within the proportional limit, plastic material shows an initial strain proportional to the modulus of elasticity, followed by a slow but steady increase in strain with time (creep). A higher starting point will provide a better result (Note: Higher E materials typically have lower CTE). The thermal compensation material may have a Heat Deflection Temperature>100° C.@1.8 MPa. Materials that soften at higher temperature tend to creep more at elevated temperatures. The thermal compensation material may also have CTE>100 μm/m° C. and a Moisture Absorption at Saturation<0.1%. For improved dimensional stability, amorphous polymers may be avoided for use as the thermal compensation material. However, crystalline or semi-crystalline polymers are more creep resistant and may be good candidates for the thermal compensation material. Further, the thermal compensation spacer may include a mix of materials with having different thermal expansion properties or may have different portions where each portion is made from a different material that each has different thermal expansion properties.

The use of plastic elements provide a low cost for the assembly. Due to the inclusion of the thermal compensation material, the lens elements can be designed with lower cost materials, such as optical plastic elements. Typically, optical glass is used for lens design to minimize thermal expansion as optical glass has lower thermal expansion than optical plastics. With the integration of the thermal compensation material in the lens housing, the higher thermal expansion of optical plastic can be compensated. Therefore, the lower cost plastic element can be used in the design. Using this design, a cost reduction of 40% may be achieved.

The lens assembly may also integrate a bandpass filter. Depending on the application, optical filtration may be beneficial. For example, if the camera application is sensing in infrared or near infrared wavelengths then filtration can be beneficial. In this case, a band pass filter can be applied which filters out visible wavelength light in favor of passing through near infrared and/or infrared wavelengths. The inclusion of a specified optical filtration in the lens design will reduce unwanted light intrusion and unwanted flare. In the case of a driver monitoring system, visible light wavelengths may not be desired and could be filtered out before reaching the imager. By including a bandpass filter in the lens design, the risk of intrusive flare light can be mitigated

FIG. 1 is a schematic illustrating thermal variation in a lens assembly. The lens assembly may be integrated into a camera used for applications where low cost and significant temperature variation are important. Such applications may include attachment to a vehicle for cabin or occupant monitoring, as well as, external object detection. However, many other indoor and outdoor uses may also be applicable. The lens assembly in FIG. 1 may include a lens 10 and a housing 12. An imaging sensor 14 may be attached to or integrated into the housing 12 such that the lens 10 focuses an image from a field of view onto the imaging sensor 14. Ray trace 18 illustrates the focusing of light signals by the lens 10 onto the imaging sensor 14 at a target temperature. Ray trace 16 illustrates the focusing of the light signals by the lens 10 in front of the imaging sensor 14 at a second temperature. The change and focus of the lens 10 may be due to mechanical dimensional changes caused by thermal expansion or contraction. The change in focus may also be due to changes in the index of refraction of the material of the lens 10 due to thermal change of the lens assembly. The change in the focus of the lens is illustrated by reference numeral 20.

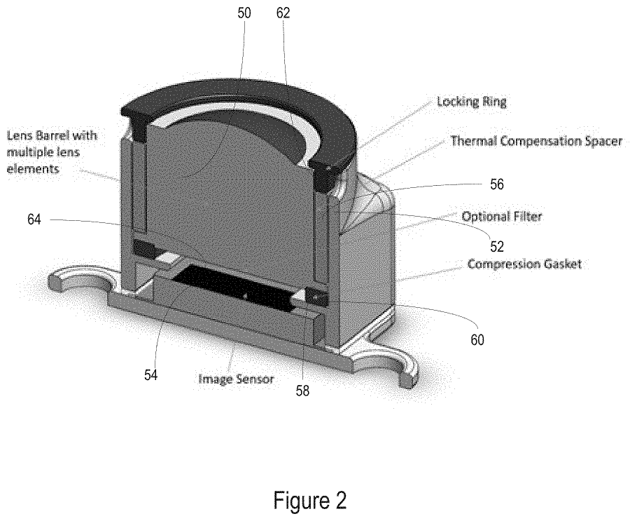

FIG. 2 is a sectional view of an optical sensor assembly that provides thermal compensation for focal changes of the lens due to temperature. In some implementations, the optical sensor assembly may be a camera assembly. The camera assembly may include a lens 50, a housing 52, an image sensor 54, and a thermal compression spacer 56. The lens 50 collects light from a field of view and focuses the light into an image on the sensor 54. The lens 50 and the imaging sensor 54 may be structurally supported and enclosed by the housing 52. As described with regard to FIG. 1, a temperature change may alter the focus of the lens 50 relative to the imaging sensor 54. The thermal compensation spacer 56 may be made of one or more materials that expand or contract based on the change of temperature. Accordingly, the amount of change of the thermal compensation spacer may be selected to match the change and focus of the lens 50 relative to the imaging sensor 54 based on one or more factors. The one or more factors may include at least one of mechanical dimensional changes of the lens assembly and a change in index of refraction of the lens 50. The thermal compensation spacer 56 may be cylindrical in shape and have an opening allowing the lens 50 to extend through the opening. As such, the lens 50 will direct the light from the image through the opening in the thermal compensation spacer 56 to the imaging sensor 54. The cylindrical nature of the thermal compensation spacer 56 provides an even support and focal change around the lens 50 preventing axial skew. As the thermal compensation spacer 56 expands, it may push one end against a lock ring 62 or a feature of the housing 52. On an opposite end of the thermal compensation spacer 56 may push against the lens 50, for example through a flange 58, to change the position of the lens relative to the imaging sensor 54 in an opposite direction of the thermal variation thereby providing a thermal correction that places the focused image at the imaging sensor 54. The camera may also include a filter 64 which may be placed between the lens 50 and imaging sensor 54.

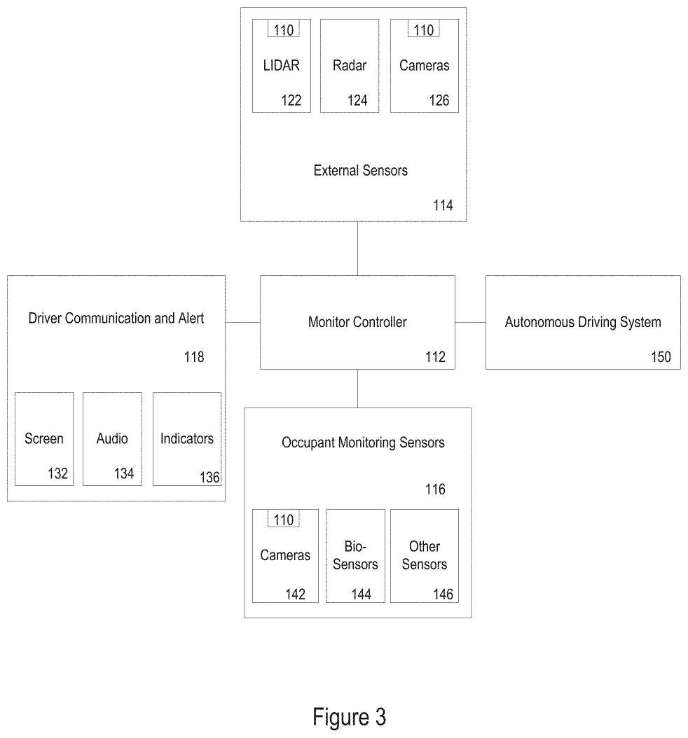

FIG. 3 is a schematic view of a monitoring system. The lens assembly and/or optical sensor assembly described above may be incorporated into such a monitoring system. For example, the lens assembly may be illustrated by reference number 110. The monitor controller 112 may monitor object within the cabin (e.g. driver, occupant, etc.) or objects external to the vehicle (e.g. cars, pedestrians, etc.). In accomplishing these tasks, the monitor controller 112 may be in communication with external sensors 114. The external sensors may monitor the environment surrounding the vehicle as the vehicle is stopped or as the vehicle proceeds along its route. The external sensors may include Lidar 122, radar 124, and cameras 126. However, it is understood that other external sensing technologies may be used, for example, ultrasonic sensors or other distance or environmental measuring sensors within the vehicle. In some examples, the sensors may include temperature sensors, moisture sensors, as well as, various features that may be derived from sensors such as the camera. These features may include whether there is a snowy condition, the amount of glare from the sun, or other external environmental conditions. The monitor controller 112 may use input from the external sensors 114 to provide environmental context to the monitor controller 112.

The monitor controller 112 may also be in communication with an occupant monitoring sensors system 116. The occupant monitoring system 116 may include cameras 142, biosensors 144, as well as other sensors 146. The cameras may be mounted in different positions, orientations, or directions within the vehicle to provide different viewpoints of occupants in the vehicle. The cameras may be used to analyze gestures by the occupants or determine the positon and/or orientation of the occupant, or monitor indications of the occupant such as facial features indicative of emotion or condition. The biosensors 144 may include touch sensors for example, to determine if the driver is touching a certain control such as the steering wheel or gear shift. The biosensors 144 could include a heart rate monitor to determine the heart rate of the passenger, as well as, other biological indications such as temperature or skin moisture. In addition, other sensors 146 may be used such as presence, absence or position sensors to determine for example, if the occupant is wearing a safety belt, a weight sensor to determine the weight of the occupant.

The monitor controller 112 may also be in communication with a driver communication and alert system 118. The driver communication and alert system 118 may include video screens 132, audio system 134, as well as other indicators 136. The screen may be a screen in the console and may be part of the instrument cluster, or a part of a vehicle infotainment system. The audio may be integrated into the vehicle infotainment system or a separate audio feature for example, as part of the navigation or telecommunication systems. The audio may provide noises such as beeps, chirps or chimes or may provide language prompts for example, asking questions or providing statements in an automated or pre-recorded voice. The driver communication and alert system 118 may also include other indicators for example, lamps or LEDs to provide a visual indication either on the instrument cluster or elsewhere in the vehicle including for example, on the side view mirrors or rear view mirror. The monitor controller 112 may also be in communication with an autonomous driving system 150. The autonomous driving system 150 may utilize input from the internal and external sensors when making driving decisions.

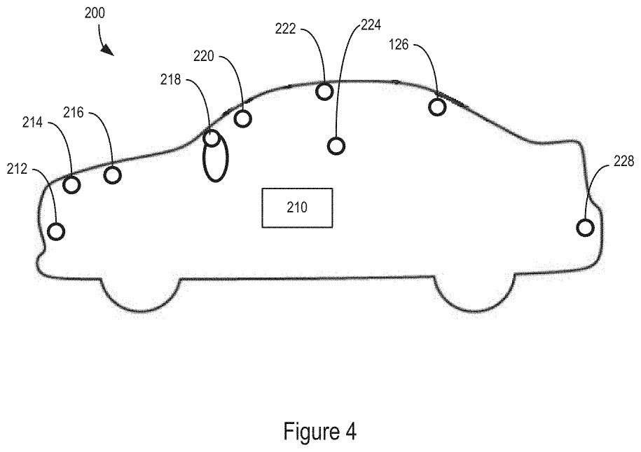

Now referring to FIG. 4, a schematic view of the vehicle 200 is provided. The vehicle may include a sensor processer 210. The sensor processer 210 may include one or more processors to monitor and/or measure the input from various vehicle sensors both inside and/or outside of the vehicle. For example, as described previously, the vehicle may include a range sensor 212, for example, an ultrasonic sensor to determine if an object is directly from another vehicle 200. The vehicle may include a radar sensor 214. The radar sensor 214 may be a forward looking radar sensor and provide distance and location information of objects that are located within the radar sensing field. As such, a vehicle may include a forward facing radar shown as radar 214. However, a rearward or sideward looking radar may also be included. The system may include a Lidar 216. The Lidar 216 may provide distance and location information for vehicles that are within the sensing field of the Lidar system. As such, the vehicle may include a forward looking Lidar system as shown with regard to Lidar 216. However, rearward or sideward looking Lidar systems may also be provided.

The vehicle 200 may also include biosensors 218. The biosensor 218 may for example, be integrated into a steering wheel of the vehicle. However, other implementations may include integration into seats and/or a seatbelt or within other vehicle controls such as the gear shift or other control knobs. Biosensor 218 may determine a heartbeat, temperature, and/or moisture of the skin of the driver of the vehicle. As such, the condition of the driver may be evaluated by measuring various biosensor readings as provided by the biosensor 218. The system may also have one or more inward or cabin facing cameras 220. The cabin facing cameras 220 may include cameras that operate in the white light spectrum, infrared spectrum, or other available wavelengths. The cameras may be used to determine various gestures of the driver, position or orientation of the driver, or facial expressions of the driver to provide information about the condition of the driver (e.g. emotional state, engagement, drowsiness and impairment of the driver). Further, bioanalysis may be applied to the images from the camera to determine the condition of the driver or if the driver has experienced some symptoms of some medical state. For example, if the driver's eyes are dilated, this may be indicative of a potential medical condition which could be taken into account in controlling the vehicle.

Cameras 222 may be used to view the external road conditions, such as in front of, behind, or to the side of the vehicle. This may be used to determine the path of the road in front of the vehicle, the lane indications on the road, the condition of the road with regard to road surface, or with regard to the environment external to the vehicle including whether the vehicle is in a rain or snow environment, as well as, lighting conditions external to the vehicle including whether there is glare or glint from the sun or other objects surrounding the vehicle as well as the lack of light due to poor road lighting infrastructure. As discussed previously, the vehicle may include rearward or sideward looking implementations of any of the previously mentioned sensors. As such, a side view mirror sensor 224 may be attached to the side view mirror of the vehicle and may include a radar, Lidar and/or camera sensor for determining external conditions relative to the vehicle including the position of objects such as other vehicles around the instant vehicle. Additionally, rearward facing camera 226 and ultrasonic sensor 228 in the rear bumper of the vehicle provide other exemplary implementations of rearward facing sensors that parallel the functionality of the forward facing sensors described previously.

Reduced cost by including a passive mechanical athermalization method may be one major benefit of the disclosed design. The design can use and integrate thermal compensation material and avoid the cost of intrinsically athermal materials such as high-quality optical glass elements. Additionally, the disclosed design may avoid the necessity for manual refocus due to thermal shift of the focus plane.

In addition to achieving athermalization, the inclusion of features such as the bandpass filtration and optical baffle may reduce the noise and stray light artifacts which can reduce performance of automotive machine vision and ADAS features.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

As a person skilled in the art will readily appreciate, the above description is meant as an illustration of the principles of this application. This description is not intended to limit the scope or application of the claim in that the assembly is susceptible to modification, variation and change, without departing from spirit of this application, as defined in the following claims.

1. A camera for attachment to a vehicle, the camera comprising:
an imaging sensor configured to detect objects within a field of view; and
a lens assembly for focusing an image of the field of view onto the imaging sensor, the lens assembly comprising a lens comprised of a plastic material such that a thermal variation is introduced into a focal length of the lens based on an ambient temperature, the lens assembly also comprising a thermal compensation spacer, the thermal compensation spacer being configured to induce a thermal correction in an opposite direction of the thermal variation to correct the focal length of the lens.

2. The camera according to claim 1, wherein the thermal compensation spacer is configured to expand such that the thermal compensation spacer is configured to push against a flange in the lens assembly to move the lens thereby correcting the thermal variation.

3. The camera according to claim 1, wherein the thermal compensation spacer is cylindrical.

4. The camera according to claim 1, wherein the lens extends through an opening in the thermal compensation spacer.

5. The camera according to claim 1, wherein the thermal compensation spacer is configured push against a flange attached to the lens.

6. The camera according to claim 1, wherein the thermal compensation spacer is configured push the lens against a compression gasket.

7. The camera according to claim 6, wherein the compression gasket is comprised to resist movement of the lens due to pushing of the thermal compensation spacer.

8. The camera according to claim 1, wherein the image is transmitted by the lens through the thermal compensation spacer to the image sensor.

9. The camera according to claim 1, wherein thermal compensation spacer is configured to move the lens to adjust for a change in index of refraction of the lens due to temperature.

10. The camera according to claim 1, wherein thermal compensation spacer is configured to move the lens to adjust for a change in mechanical dimensions of the lens due to temperature.

11. A camera for attachment to a vehicle, the camera comprising:
an imaging sensor configured to detect objects within a field of view; and
a lens assembly configured to focus an image of the field of view onto the imaging sensor, the lens assembly comprising a lens comprised of a plastic material such that a thermal variation is introduced into a focal length of the lens based on an ambient temperature, the lens assembly also comprising a thermal compensation spacer, the thermal compensation spacer being configured to induce a thermal correction in an opposite direction of the thermal variation to correct the focal length of the lens thereby focusing the image on the image sensor, wherein thermal compensation spacer is configured to move the lens to adjust for a change in index of refraction and mechanical dimensions of the lens due to temperature.

12. An optical sensor assembly comprising:
a sensor configured to sense a light signal; and
a lens assembly for directing the light signal onto the sensor, the lens assembly comprising a lens comprised of a plastic material such that a thermal variation is introduced into a focal length of the lens based on temperature, the lens assembly also comprising a thermal compensation spacer, the thermal compensation spacer being configured to induce a thermal correction in an opposite direction of the thermal variation to correct the focal length of the lens.

13. The optical sensor assembly according to claim 12, wherein the thermal compensation spacer is configured to expand such that the thermal compensation spacer is configured to push against a flange in the lens assembly to move the lens thereby correcting the thermal variation.

14. The optical sensor assembly according to claim 12, wherein the thermal compensation spacer is cylindrical.

15. The optical sensor assembly according to claim 12, wherein the lens extends through an opening in the thermal compensation spacer.

16. The optical sensor assembly according to claim 12, wherein the thermal compensation spacer is configured push against a flange attached to the lens.

17. The optical sensor assembly according to claim 12, wherein the thermal compensation spacer is configured push the lens against a compression gasket.

18. The optical sensor assembly according to claim 17, wherein the compression gasket is comprised to resist movement of the lens due to pushing of the thermal compensation spacer.

19. The optical sensor assembly according to claim 12, wherein the light signal is transmitted by the lens through the thermal compensation spacer to the sensor.

20. The optical sensor assembly according to claim 12, wherein thermal compensation spacer is configured to move the lens to adjust for a change in index of refraction of the lens due to temperature.
